(19) United States
(12) Patent Application Publication
(10) Pub. No.: US 2004/0196232 A1
(43) Pub. Date: Oct. 7, 2004

(54) Liquid crystal display, and apparatus and method of driving liquid crystal display

(76) Inventors: Dong-Hwan Kim, Yongin-city (KR); Dong-Wan Choi, Seoul (KR); Bo-Young An, Yongin-city (KR)

Correspondence Address: GRAY CARY WARE & FREIDENRICH LLP, 2000 UNIVERSITY AVENUE, E. PALO ALTO, CA, 94303-2248, US

(21) Appl. No.: 10/728,000

(22) Filed: Dec. 3, 2003

(30) Foreign Application Priority Data
Dec. 4, 2002 (KR) 2002-0076605

(51) Int. Cl. G09G 3/36

(52) U.S. Cl. 345/89

(57) ABSTRACT

An apparatus for driving a liquid crystal display includes a data driver alternately applying first data voltages and second voltages to pixels for a horizontal period and a signal controller changing a state of an inversion signal between an end of the transmission of first image data corresponding to the first data voltages and a start of the transmission of second image data corresponding the second data voltages and the polarity of the common voltage between an end of the application of the data voltages for a row and a start of the application of the data voltages for a next row.

### BACKGROUND OF THE INVENTION

(a) Field of the Invention

The present invention relates to a liquid crystal display, and an apparatus and method for driving the liquid crystal display.

(b) Description of the Related Art

Liquid crystal displays (LCDs) include two panels having pixel electrodes and a common electrode and a liquid crystal (LC) layer with dielectric anisotropy, which is interposed between the two panels. The liquid crystal layer is applied with electric field by applying voltages to the two electrodes, and the transmittance of light passing through the liquid crystal layer is adjusted by controlling the electric field, thereby obtaining desired images. The pixel electrodes are arranged in a matrix and connected to switching elements such as thin film transistors (TFTs). The switching elements selectively transmit data voltages from data lines in response to gate signals from gate lines. The common electrode covers entire surface of one of the two panels and is supplied with a common voltage.

In order to prevent image deterioration due to long-time application of the unidirectional electric field, polarity of data voltages with respect to the common voltage is reversed every frame, every row, or every dot. Along with the polarity inversion of the data voltages, a common voltage modulation is used to reduce power consumption. The common voltage modulation is to change the magnitude of the common voltage in synchronization with the polarity inversion of the data voltages instead of fixing the magnitude of the common voltage, thereby reducing the amplitude of the data voltages.

However, as described above, since the common electrode covers entire surface of one of the two panels, the magnitude of the common voltage applied to adjacent pixels may not be different. Therefore, the magnitude of the common voltage applied to the pixels in one row supplied with the data voltages at the same time should be equal, and thus the common voltage modulation may be not used for a dot inversion LCD.

In a line inversion LCD, different pixel rows are supplied with the data voltages at different times and the magnitude of the common voltage may be changed every row using the common voltage modulation. In this case, image data for a row from a signal controller are sequentially stored into a data driver together with an inversion signal for determining the polarity of the image data, and they are applied to the LCD panel assembly when all the image data for the row are stored into the data driver after one horizontal period from the start of the data storing. However, because the common voltage is directly applied to the LCD panel assembly not through the data driver, the inversion signal is delayed by a horizontal period than the periodic common voltage.

In the meantime, the line inversion often enhances flicker phenomenon. In an LCD for a cellular phone, etc., having a small display screen and a low operating frequency, image deterioration such as the flicker phenomenon is not a significant problem since the user hardly perceives the flicker. However, it becomes increasingly important as the size of the display screen of an LCD becomes large.

### SUMMARY OF THE INVENTION

An apparatus for driving a liquid crystal display including a plurality of pixels connected to gate lines and data lines and arranged in a matrix is provided, which includes: a gray voltage generator generating a plurality of gray voltages; a data driver selecting data voltages corresponding to image data from the gray voltages and applying the data voltages to the pixels; and a signal controller transmitting the image data for the data driver and generating and outputting control signals for controlling the image data to the data driver, wherein the data voltages include first data voltages for odd pixels and second data voltages for an even pixels, the image data include the first image data for the first data voltages and the second image data for the second data voltages, the data driver applies the first data voltages and the second voltages to the pixels in turn for a horizontal period, the control signals include an inversion signal for reversing the polarity of the first and the second data voltages and a common voltage applied to the pixels having a magnitude varying dependent on the polarity of the data voltages, and the signal controller changes a state of the inversion signal between an end of the transmission of the first image data and a start of the transmission of the second image data and the polarity of the common voltage between an end of the application of the data voltages for a row and a start of the application of the data voltages for a next row.

A phase of the common voltage is preferably delayed by half of a horizontal period with respect to a phase of the inversion signal.

A period of the inversion signal and a period of the common voltage are preferably equal to two horizontal periods.

According to an aspect of the present invention, a liquid crystal display is provided, which includes: a plurality of pixels arranged in a matrix; a plurality of odd and even data lines and gate lines transferring signals to the pixels; a gray voltage generator generating a plurality of gray voltages; a data driver selecting data voltages corresponding to image data from the gray voltages and applying the data voltages to the pixels; and a transmission gate unit including a plurality of odd switching elements connected to the odd data lines and a plurality of even switching element connected to the even data lines, and connected to the data driver; and a signal controller transmitting the image data to the data driver and generating and outputting control signals for controlling the image data to the data driver and the transmission gate unit, wherein the odd switching elements and the even switching elements are connected to each other in pairs, the data voltages include first data voltages for odd pixels and second data voltages for an even pixels, the image data include the first image data for the first data voltages and the second image data for the second data voltages, the data driver applies the first data voltages and the second voltages to the pixels in turn for a horizontal period, the signal controller controls the transmission gate unit to alternately turn on the odd switching elements and the even switching elements such that the first data voltages and the second data voltages are applied to the corresponding pixels, the control signals include an inversion signal for reversing the polarity of the first and the second data voltages and a common voltage applied to the pixels having a magnitude varying dependent on the polarity of the data voltages, and the signal controller changes a state of the inversion signal between an end of the transmission of the first image data and a start of the transmission of the second image data and the polarity of the common voltage between an end of the application of the data voltages for a row and a start of the application of the data voltages for a next row.

A phase of the common voltage is preferably delayed by half of a horizontal period with respect to a phase of the inversion signal.

A period of the inversion signal and a period of the common voltage are preferably equal to two horizontal periods.

Preferably, the control signals further includes a first switching driving signal driving the odd switching elements and a second switching driving signal driving the even switching elements, and the signal controller alternately applies the first switching driving signal and the second driving signal to the odd switching elements and the even switching elements.

According to another aspect of the present invention, a liquid crystal display is provided, which includes: a plurality of odd and even pixels and arranged in a matrix, each pixel including a switching element; a plurality of first gate lines connected to the odd pixels; a plurality of second gate lines connected to the even pixels; a plurality of data lines connected to the pixels; a gray voltage generator generating a plurality of gray voltages; a first gate driver connected to the first gate lines to drive the switching elements of the odd pixels; a second gate driver connected to the second gate lines to drive the switching elements of the even pixels; a data driver selecting data voltages corresponding to image data from the gray voltages and applying the data voltages to the pixels; and a signal controller transmitting the image data to the data driver and generating and outputting control signals for controlling the image data to the data driver, wherein the data voltages include first data voltages for odd pixels and second data voltages for an even pixels, the image data include the first image data for the first data voltages and the second image data for the second data voltages, each pair of the first and the second gate lines connected to the odd and even pixels in a row are alternately supplied with a gate-on voltage from the first and the second gate drivers, respectively, to turn on the switching elements connected thereto for one horizontal period, the data driver outputs the first voltages for the odd pixels during a period that the first switching elements are turned on and outputs the second voltages for the even pixels during a period that the second switching elements are turned on, the control signals include an inversion signal for reversing the polarity of the first and the second data voltages and a common voltage applied to the pixels having a magnitude varying dependent on the polarity of the data voltages, and the signal controller changes a state of the inversion signal between an end of the transmission of the first image data and a start of the transmission of the second image data and the polarity of the common voltage between an end of the application of the data voltages for a row and a start of the application of the data voltages for a next row.

A phase of the common voltage is preferably delayed by half of a horizontal period with respect to a phase of the inversion signal.

A period of the inversion signal and a period of the common voltage are preferably equal to two horizontal periods.

The odd pixels and the even pixels are preferably connected to the data lines in pairs.

A method of driving the liquid crystal display including a plurality of odd and even pixels arranged in a matrix is provided, which includes: supplying image data for the odd pixels, an inversion signal, and a common voltage; reversing a state of the inversion signal; supplying image data for the even pixels; and reversing a state of the common voltage.

### BRIEF DESCRIPTION OF THE DRAWINGS

The present invention will become more apparent by describing embodiments thereof in detail with reference to the accompanying drawings in which:

FIG. 1 is a block diagram of an LCD according to an embodiment of the present invention;

FIG. 2 is an equivalent circuit diagram of a pixel of an LCD according to an embodiment of the present invention;

FIG. 3 is a block diagram of a data driver of an LCD according to an embodiment of the present invention;

FIG. 4 is a time chart of an LCD according to an embodiment of the present invention;

FIG. 5 is a block diagram of an LCD of a dual gate type according to another embodiment of the present invention; and

FIG. 6 is a time chart of an LCD of a dual gate type according to another embodiment of the present invention.

### DETAILED DESCRIPTION OF EMBODIMENTS

The present invention now will be described more fully hereinafter with reference to the accompanying drawings, in which embodiments of the invention are shown. This invention may, however, be embodied in many different forms and should not be construed as limited to the embodiments set forth herein. Like numerals refer to like elements throughout.

In the drawings, the thickness of layers and regions are exaggerated for clarity. Like numerals refer to like elements throughout. It will be understood that when an element such as a layer, region or substrate is referred to as being “on” another element, it can be directly on the other element or intervening elements may also be present. In contrast, when an element is referred to as being “directly on” another element, there are no intervening elements present.

Then, LCDs, apparatus and methods for driving the LCDs according to embodiments of the present invention will be described with reference to the accompanying drawings.

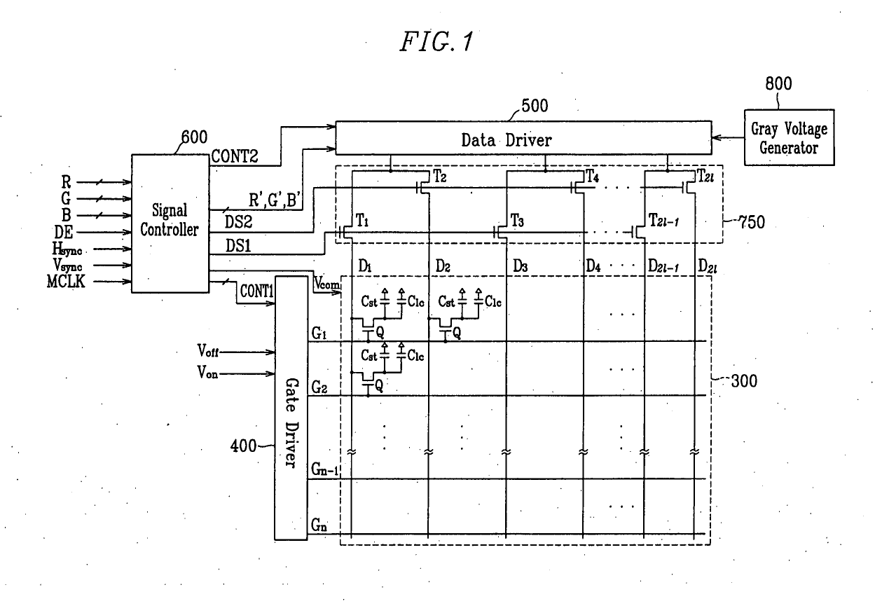

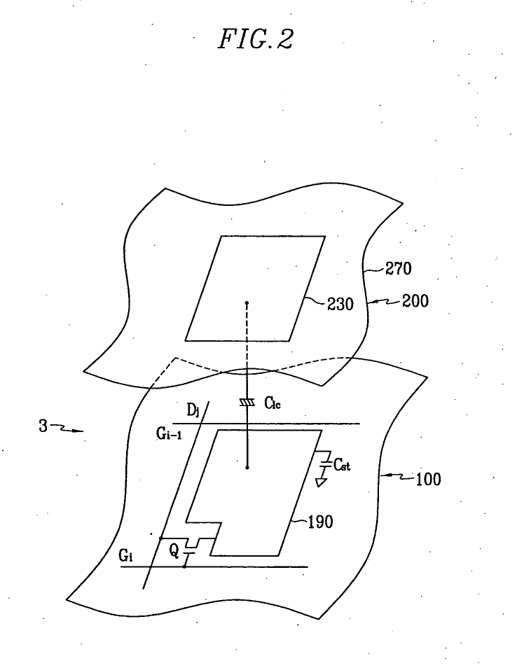

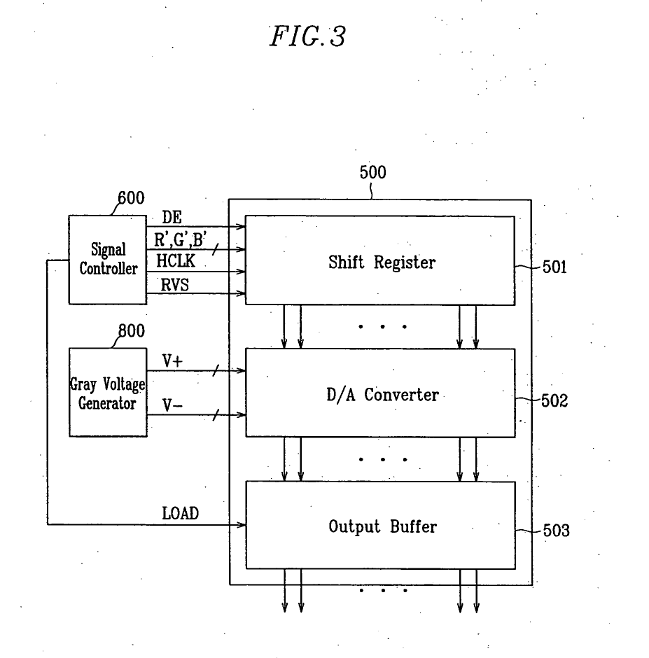

FIG. 1 is a block diagram of an LCD according to an embodiment of the present invention, and FIG. 2 is an equivalent circuit diagram of a pixel of an LCD according to an embodiment of the present invention. FIG. 3 is a block diagram of a data driver of an LCD according to an embodiment of the present invention.

Referring to FIG. 1, an LCD according to an embodiment of the present invention, which is a transmission gate type LCD, includes an LC panel assembly 300, a gate driver 400 and a transmission gate unit 750 which are connected to the panel assembly 300, a data driver 500 connected to the transmission gate unit 750, a gray voltage generator 800 connected to the data driver 500, and a signal controller 600 controlling the above elements.

In circuital view, the LC panel assembly 300 includes a plurality of display signal lines G₁-Gₙ and D₁-Dₘ and a plurality of pixels connected thereto and arranged substantially in a matrix.

The display signal lines G₁-Gₙ, and D₁-Dₘ include a plurality of gate lines G₁-Gₙ transmitting gate signals (also referred to as “scanning signals”), and a plurality of data lines D₁-Dₘ transmitting data signals. The gate lines G₁-Gₙ extend substantially in a row direction and substantially parallel to each other, while the data lines D₁-Dₘ extend substantially in a column direction and substantially parallel to each other.

Each pixel includes a switching element Q connected to the signal lines G₁-Gₙ and D₁-Dₘ, and a LC capacitor C_{LC} and a storage capacitor C_{ST} that are connected to the switching element Q. If necessary, the storage capacitor C_{ST} may be omitted.

The switching element Q is provided on a lower panel 100 and has three terminals, a control terminal connected to one of the gate lines G₁-Gₙ, an input terminal connected to one of the data lines D₁-Dₘ, and an output terminal connected to both the LC capacitor C_{LC} and the storage capacitor C_{ST}.

The LC capacitor C_{LC} includes a pixel electrode 190 provided on the lower panel 100 and a common electrode 270 provided on an upper panel 200 as two terminals. The LC layer 3 disposed between the two electrodes 190 and 270 functions as dielectric of the LC capacitor C_{LC}. The pixel electrode 190 is connected to the switching element Q and the common electrode 270 is connected to the common voltage V_{com} and covers entire surface of the upper panel 200. Unlike FIG. 2, the common electrode 270 may be provided on the lower panel 100, and both electrodes 190 and 270 have shapes of bar or stripe.

The storage capacitor C_{ST} is defined by the overlap of the pixel electrode 190 and a separate wire (not shown) provided on the lower panel 100 and applied with a predetermined voltage such as the common voltage V_{com}. Otherwise, the storage capacitor C_{ST} is defined by the overlap of the pixel electrode 190 and its previous gate line Gᵢ₋₁ via an insulator.

For color display, each pixel can represent its own color by providing one of a plurality of red, green and blue color filters 230 in an area corresponding to the pixel electrode 190. The color filter 230 shown in FIG. 2 is provided in the corresponding area of the upper panel 200. Alternatively, the color filters 230 are provided on or under the pixel electrode 190 on the lower panel 100.

The LC molecules in the LC capacitor C_{LC} have orientations depending on the variation of electric field generated by the pixel electrode 190 and the common electrode 270, and the molecular orientations determine the polarization of light passing through the LC layer 3. A polarizer or polarizers (not shown) attached to at least one of the panels 100 and 200 convert the light polarization into the light transmittance.

Referring to FIG. 1 again, the gray voltage generator 800 generates two sets of a plurality of gray voltages V+ and V− related to the transmittance of the pixels. The gray voltages in one set have a positive polarity (+) with respect to the common voltage V_{com}, while those in the other set have a negative polarity (−) with respect to the common voltage V_{com}.

The gate driver 400 is connected to the gate lines G₁-Gₙ of the LC panel assembly 300 and applies gate signals from an external device to the gate lines G₁-Gₙ, each gate signal being a combination of a gate-on voltage Vₒₙ and a gate-off voltage V_{off}.

The data driver 500 is connected to the transmission gate unit 750 and it selects the gray voltages V+ and V− from the gray voltage generator 800 and applies the selected gray voltages as the data signals to the transmission gate unit 750. As shown in FIG. 3, the data driver 500 includes a shift register 501, a digital/analog converter (hereinafter, referred to as “D/A converter”) 502 connected to the shift register 501, and an output buffer 503 connected to the D/A converter 502. The shift register 501 and the output buffer 503 are connected to the signal controller 600 and the D/A converter 502 is connected to the gray voltage generator 800.

The transmission gate unit 750 includes a plurality of transistors T₁-T₂ₗ and the number of the transistors T₁-T₂ₗ is equal to that of the data lines D₁-D₂ₗ of the panel assembly 300. Each transistor T₁-T₂ₗ has an input terminal connected to the data driver 500 and an output terminal connected to a corresponding data line D₁-D₂ₗ.

The output terminals of the odd transistors T₁, T₃, T₅, . . . , T₂ₗ₋₁ are connected to the odd data lines D₁, D₃, D₅, . . . , D₂ₗ₋₁, while the output terminals of the even transistors T₂, T₄, T₆, . . . , T₂ₗ are connected to the even data lines D₂, D₄, D₆, . . . , D₂ₗ. The input terminals of the odd transistors T₁, T₃, T₅, . . . , T₂ₗ₋₁, and the even transistors T₂, T₄, T₆, . . . , T₂ₗ are connected to each other in pairs.

The control terminals of the odd transistors T₁, T₃, T₅, . . . , T₂ₗ₋₁ and the even transistors T₂, T₄, T₆, . . . , T₂ₗ are supplied with different signals, for example, having a reversed relation.

Each transistor T₁-T₂ₗ in this embodiment is an N-type metal-oxide-silicon (MOS) transistor, but it may be a P-type MOS transistor.

The signal controller 600 controls the gate driver 400, the data driver 500, and the transmission gate unit 750.

Then, operations of the LCD will be described in detail.

The signal controller 600 is supplied from an external graphics controller (not shown) with RGB image signals R, G and B and input control signals controlling the display thereof, for example, a vertical synchronization signal V_{sync}, a horizontal synchronization signal H_{sync}, a main clock CLK, a data enable signal DE, etc. The signals controller 600 generates a plurality of gate control signals CONT1, a plurality of data control signals CONT2, a pair of data selection signals DS1 and DS2, and the common voltage V_{com} and processes the image signals R, G and B for the LC panel assembly 300 on the basis of the input image data R, G and B and the input control signals. The signal controller 600 provides the gate control signals CONT1 for the gate driver 400, the data control signals CONT2 and the processed image signals R′, G′ and B′ for the data driver 500, the data selection signals DS1 and DS2 for the transmission gate unit 750, and the common voltage V_{com} for the LC panel assembly 300.

The gate control signals CONT1 include a vertical synchronization start signal STV for informing of start of a frame, a gate clock signal CPV for controlling the output time of the gate-on voltage Vₒₙ, and an output enable signal OE for defining the durations of the gate-on voltage Vₒₙ.

The data control signals CONT2 include a horizontal synchronization start signal STH for informing of start of a horizontal period, a load signal LOAD or TP for instructing to apply the appropriate data voltages to the data lines D₁-Dₘ, an inversion control signal RVS for reversing the polarity of the data voltages (with respect to the common voltage V_{com}), and a data clock signal HCLK.

The common voltage V_{com} generated by the signal controller 600 becomes to have a predetermined level by a level shifter (not shown) and the level-shifted common voltage V_{com} is supplied for the LC panel assembly 300. According to the other embodiment of the present invention, the common voltage V_{com} is not generated by the signal controller 600, but by a separate common voltage generator (not shown) based on the inversion signal RVS fed from the signal controller 600.

The data driver 500 receives a packet of the image data R′, G′ and B′ for odd pixel columns and even pixel columns from the signal controller 600, converts the image data R′, G′ and B′ into analog data voltages selected from the gray voltages V+ and V−, and outputs the converted data voltages to the data lines D₁-D₂ₗ.

Responsive to the gate control signals CONT1 from the signal controller 600, the gate driver 400 applies the gate-on voltage Vₒₙ to the gate line G₁-Gₙ, thereby turning on the switching elements Q connected thereto.

At this time, the signal controller 600 supplies the data selection signal DS1 in a high state for the odd transistors T₁, T₃, T₅, . . . , T₂ₗ₋₁, while it supplies the data selection signal DS2 in a low state for the even transistors T₂, T₄, T₆, . . . , T₂ₗ. Then, the odd transistors T₁, T₃, T₅, . . . , T₂ₗ₋₁ turn on to apply the data voltages to the odd data lines D₁, D₃, D₅, . . . , D₂ₗ₋₁. Consecutively, the signal controller 600 changes the states of the data selection signals DS1 and DS2 to turn off the odd transistors T₁, T₃, T₅, . . . , T₂ₗ₋₁ and to turn on the even transistors T₂, T₄, T₆, . . . , T₂ₗ. Then, the data voltages are supplied to the even transistors T₂, T₄, T₆, . . . , T₂ₗ connected to the even data lines D₂, D₄, D₆, . . . , D₂ₗ.

The relation between the state of the data selection signal DS1 or DS2 and the activation of the transistors T₁-T₂ₗ is reversed when the transistors T₁-T₂₁ are P type MOS transistors.

Then, the data voltages in turn are supplied to the corresponding pixels via the activated switching elements Q.

As a result, the data signals are supplied in turn for the odd pixels and the even pixels for one horizontal period (often indicated as “1H,” which is equal to one period of the horizontal synchronization signal H_{sync}, the data enable signal DE, and the data clock signal CPV). At the same time, the odd pixels and the even pixels are supplied with the common voltage V_{com} with different magnitudes.

By repeating this procedure, all gate lines G₁-Gₙ are sequentially supplied with the gate-on voltage Vₒₙ during a frame, and all the pixels are supplied with the data voltages.

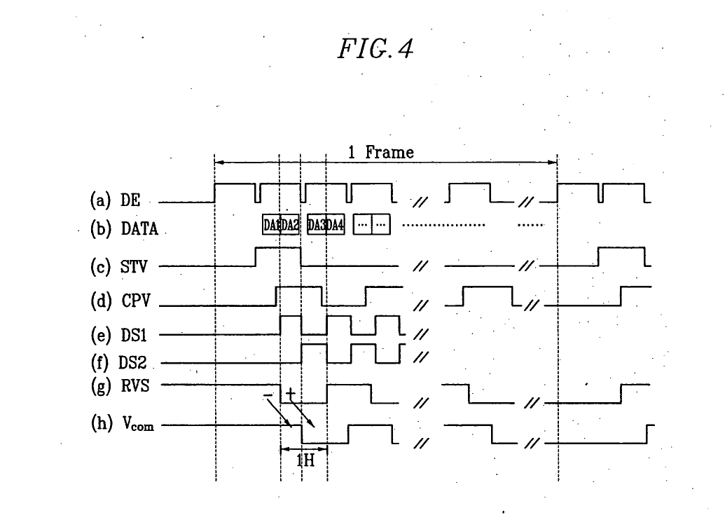

The above-described operation will be described in detail with reference to FIGS. 3 and 4.

FIG. 4 is a time chart of an LCD according to an embodiment of the present invention.

When the data enable signal DE applied from an external graphics controller (not shown) into the signal controller 600 is in a high state, the image data DA1 for the pixels in the odd columns are sequentially transmitted from the signal controller 600 to the data driver 500 to be stored into the shift register 501. Besides, the inversion signal RVS defining the polarity of the data voltages is stored into the shift register 501, too. Referring to FIG. 4, when the inversion signal RVS is in a high state, the data voltages corresponding to the image data have negative polarity, and vice versa. Therefore, the data voltages corresponding to the image data DA1 for the pixels in the odd columns are negative polarity. The period of the inversion signal RVS is equal to two horizontal periods.

After all the image data DA1 are stored in the shift resister 501, the image data DA1 are supplied for the D/A converter 502 together with the inversion signal RVS, such that the D/A converter 502 selects data voltages from one of two sets of the positive and the negative gray voltages V+ and V−. In FIG. 4, the D/A converter 502 selects the data voltages from the negative gray voltages V− and outputs the data voltages to the output buffer 503.

Meanwhile, when the vertical synchronization start signal STV becomes high and the time goes ½ horizontal period from the input of the image data DA1, the gate clock signal CPV is changed from a low state into a high state, and thus the gate driver 400 supplies the gate-on voltage Vₒₙ for an appropriate gate line. In addition, the signal controller 600 applies the load signal LOAD to the output buffer 503 and changes the data selection signal DS1 to be supplied for the transmission gate unit 750 from the low state into a high state. Accordingly, the odd transistors T₁, T₃, T₅, . . . , T₂ₗ₋₁ of the transmission gate unit 750 are turned on, and the data voltages corresponding to the odd image date DA1 are applied to the odd data lines D₁, D₃, D₅, . . . , D₂ₗ₋₁ through the turned-on odd transistors T₁, T₃, T₅, . . . , T₂ₗ₋₁.

At the same time, the signal controller 600 outputs the common voltage V_{com} depending on the polarity of the data voltages corresponding to the image data DA1. The common voltage V_{com} has two values, a high value and a low value based on the polarity of the data voltages. The high value is chosen for the positive polarity data voltages, while the low value is chosen for the negative polarity data voltages, for reducing the amplitude of the gray voltages as described above. In FIG. 4, the common voltage V_{com} has the low value because the data voltages corresponding to the image data DA1 have the negative polarity.

Accordingly, the data voltages with the negative polarity are applied to the odd pixels of the LC panel assembly 300 via the odd data lines D₁, D₃, . . . , D₂ₗ₋₁ and the common voltage V_{com} applied to the LC panel assembly 300 has the high value.

During the application of the data voltages corresponding to the odd image data DA1 to the LC panel assembly 300, the shift register 501 is supplied with image data DA2 for the even pixel columns. At that time, the inversion signal RVS is changed in its state from the high state into the low state and it is stored into the shift register 501. That is, the polarity of the data voltages corresponding to the image data DA2 becomes positive.

When all the even image data DA2 are stored into the shift register 502 and the application of the odd image data DA1 is completed, the even image data DA2 are supplied for the D/A converter 502 together with the inversion signal RVS. The D/A converter 502 selects the data voltages corresponding to the image data DA2 from the positive polarity gray voltages V+ and outputs the selected data voltages to the output buffer 503.

Subsequently, the signal controller 600 supplies the load signal LOAD for the output buffer 503, changes the state of the data selection signal DS1 from the high state into the low state, and changes state of the data selection signal DS2 from the low state into the high state. Accordingly, the odd transistors T₁, T₃, T₅, . . . , T₂ₗ₋₁ are turned off, while the even transistors T2, T4, T6, . . . , T2l are turned on such that the data voltages corresponding to the even image data DA2 from the output buffer 503 are applied to the even data lines D₂, D₄, D₆, . . . , D₂ₗ. At the same time, the signal controller 600 changes the value of the common voltage V_{com} from the low value into the high value in accordance with the polarity change of the data voltages for the image data DA2.

Accordingly, the data voltages with the positive polarity are applied to the even pixels of the LC panel assembly 300 via the even data lines D₂, D₄, . . . , D₂ₗ and the common voltage V_{com} applied to the panel assembly 300 is changed from the high value to the low value at the same time.

According to this embodiment, the signal controller 600 controls the signals such that the state of the inversion signal RVS for the odd image data DA1 is different from that for the even image data DA2 and the period of the inversion signal RVS is equal to two horizontal periods. Furthermore, the signal controller 600 controls the signals such that the phase of the common voltage V_{com} is delayed by ¼ period with respect to the phase of the inversion signal RVS to differ the polarity of the data voltages for the odd pixels from that for the even pixels. As shown in FIG. 4, the polarity of the inversion signal RVS is changed at a time between the transmissions of the odd image data DA1 and the even image data DA2 and the value of the common voltage V_{com} is changed at a time between image data for adjacent columns outputted from the signal controller 600.

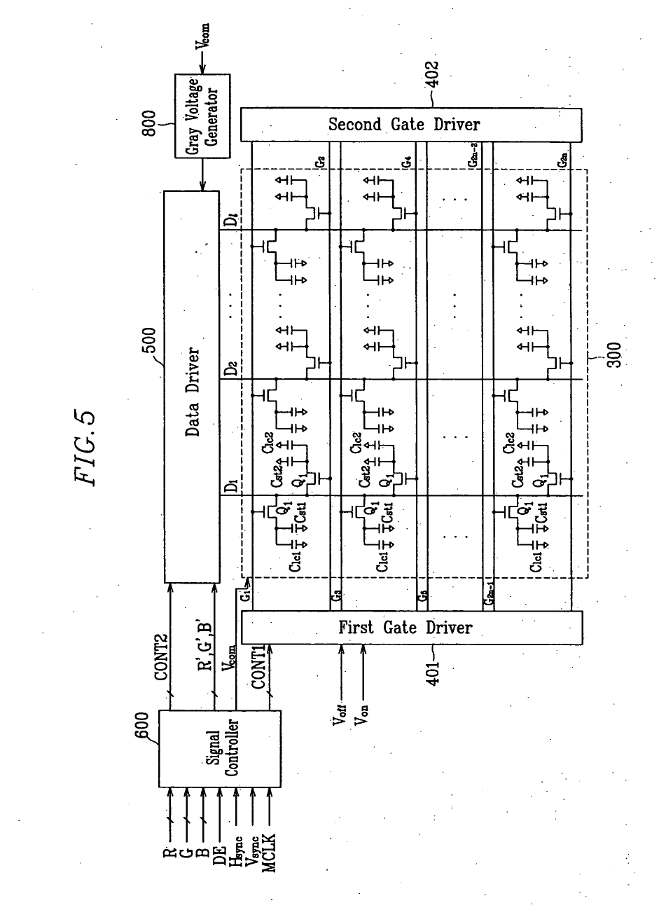

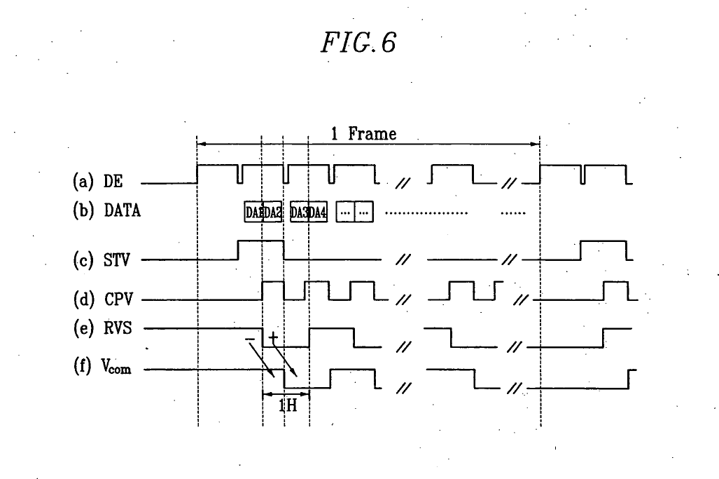

A dual gate type LCD according to an embodiment of the present invention will be described with reference to FIGS. 5 and 6.

FIG. 5 is a block diagram of a dual gate type LCD according to an embodiment of the present invention and FIG. 6 is a timing chart of an LCD of a dual gate type according to another embodiment of the present invention.

Referring to FIG. 5, an LCD according to this embodiment includes an LC panel assembly 300 having a structure different from that shown in FIG. 1 and two gate drivers 401 and 402 located on left and right sides of the LC panel assembly 300 instead of the transmission gate unit 750 shown in FIG. 1. The LCD also includes a data driver 500 connected to the LC panel assembly 300, a gray voltage generator 800 connected to the data driver 500, and a signal controller 600 controlling the above elements.

As shown in FIG. 5, two gate lines are assigned to one pixel row, one connected to odd pixels and the other connected to even pixels. A pair of adjacent odd and even pixels are connected to one data line. Accordingly, as compared with the LCD shown in FIG. 1, the number of the gate lines G₁-G₂ₙ is increased twice, but the number of the data lines D₁-Dₘ is decreased to half. This configuration of the LCD enables to differentiate the application time of data voltages for the odd pixels and the even pixels.

Next, the display operation of the LCD shown in FIG. 5 will be described in detail with reference to FIGS. 5 and 6.

When the vertical synchronization start signal STV is applied to the first gate driver 401, the first gate driver 401 selects the gate-on voltage Vₒₙ between two voltages Vₒₙ and V_{off} supplied from the driving voltage generator 700 and outputs the gate-on voltage Vₒₙ to a first gate line G₁, while it outputs the gate-off voltage V_{off} to the other gate lines G₃-G₂ₙ₋₁. At this time, the second gate driver 402 outputs the gate-off voltage V_{off} to the even gate lines G₂-G₂ₙ. Then, all switching elements Q1 connected to the first gate line G₁ are turned on, and then the data voltages are applied to the odd pixels in the first row through the data lines D₁-Dₘ.

After the charging of LC capacitors C_{LC1} and storage capacitors C_{ST1} is completed, the first gate driver 401 applies the gate-off voltage V_{off} to the first gate line G₁, while the second gate driver 402 applies the gate-on voltage Vₒₙ to the second gate line G₂. Then, the switching elements Q₂ connected a second gate line G₂ are turned on to transmit the data signals to the even pixels via the data lines D₁-Dₘ. At that time, the state change of the gate signal applied to the first gate line G₁ functions as a carry signal making the second gate driver 402 start application of the gate-on voltage Vₒₙ, and, on the contrary, the state change of the gate signal applied to the second gate line G₂ functions as a carry signal for the first gate driver 401.

Consecutively, the gate driver 401 applies the gate-on voltage Vₒₙ to the third gate line G₃, and so on, thereby repeating the above operations.

In this manner, when the data signals are applied to the switching elements Q₂ connected to a last gate line G₂, the scanning for one frame is completed.

In this embodiment, the gate-on voltage Vₒₙ is sequentially applied to two gate lines for driving all pixels in a row. Therefore, the period of the gate clock signal CPV is decreased to half as compared with that shown in FIG. 4. As shown in FIG. 6, when the gate clock signal CPV is in the high state, the first gate driver 401 applies the gate-on voltage Vₒₙ to the odd gate lines G₁-G₂ₙ₋₁, while the second gate driver 402 applies the gate-on voltage Vₒₙ to the even gate lines G₂-G₂ₙ when the gate clock signal CPV is in the low state.

As described above, when the polarity inversion of the data voltages as well as the common voltage modulation is performed, the inversion signal has a period equal to two horizontal periods and a polarity reversed at a time between the odd data and the even data. Furthermore, the phase of the common voltage is delayed by ½ horizontal period, as compared with that of the inversion signal. Therefore, flicker phenomenon generated due to the line inversion is prevented and the image quality of an LCD is increased.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. An apparatus for driving a liquid crystal display including a plurality of pixels connected to gate lines and data lines and arranged in a matrix, the apparatus comprising:
a gray voltage generator generating a plurality of gray voltages;
a data driver selecting data voltages corresponding to image data from the gray voltages and applying the data voltages to the pixels; and
a signal controller transmitting the image data for the data driver and generating and outputting control signals for controlling the image data to the data driver,
wherein the data voltages include first data voltages for odd pixels and second data voltages for an even pixels, the image data include the first image data for the first data voltages and the second image data for the second data voltages, the data driver applies the first data voltages and the second voltages to the pixels in turn for a horizontal period, the control signals include an inversion signal for reversing the polarity of the first and the second data voltages and a common voltage applied to the pixels having a magnitude varying dependent on the polarity of the data voltages, and the signal controller changes a state of the inversion signal between an end of the transmission of the first image data and a start of the transmission of the second image data and the polarity of the common voltage between an end of the application of the data voltages for a row and a start of the application of the data voltages for a next row.

2. The apparatus of claim 1, wherein a phase of the common voltage is delayed by half of a horizontal period with respect to a phase of the inversion signal.

3. The apparatus of claim 1, wherein a period of the inversion signal and a period of the common voltage are equal to two horizontal periods.

4. A liquid crystal display comprising:
a plurality of pixels arranged in a matrix;
a plurality of odd and even data lines and gate lines transferring signals to the pixels;
a gray voltage generator generating a plurality of gray voltages;
a data driver selecting data voltages corresponding to image data from the gray voltages and applying the data voltages to the pixels; and
a transmission gate unit including a plurality of odd switching elements connected to the odd data lines and a plurality of even switching element connected to the even data lines, and connected to the data driver; and
a signal controller transmitting the image data to the data driver and generating and outputting control signals for controlling the image data to the data driver and the transmission gate unit,
wherein the odd switching elements and the even switching elements are connected to each other in pairs, the data voltages include first data voltages for odd pixels and second data voltages for an even pixels, the image data include the first image data for the first data voltages and the second image data for the second data voltages, the data driver applies the first data voltages and the second voltages to the pixels in turn for a horizontal period, the signal controller controls the transmission gate unit to alternately turn on the odd switching elements and the even switching elements such that the first data voltages and the second data voltages are applied to the corresponding pixels, the control signals include an inversion signal for reversing the polarity of the first and the second data voltages and a common voltage applied to the pixels having a magnitude varying dependent on the polarity of the data voltages, and the signal controller changes a state of the inversion signal between an end of the transmission of the first image data and a start of the transmission of the second image data and the polarity of the common voltage between an end of the application of the data voltages for a row and a start of the application of the data voltages for a next row.

5. The liquid crystal display of claim 4, wherein a phase of the common voltage is delayed by half of a horizontal period with respect to a phase of the inversion signal.

6. The liquid crystal display of claim 4, wherein a period of the inversion signal and a period of the common voltage are equal to two horizontal periods.

7. The liquid crystal display of claim 6, wherein the control signals further includes a first switching driving signal driving the odd switching elements and a second switching driving signal driving the even switching elements, and the signal controller alternately applies the first switching driving signal and the second driving signal to the odd switching elements and the even switching elements.

8. A liquid crystal display comprising:
a plurality of odd and even pixels and arranged in a matrix, each pixel including a switching element;
a plurality of first gate lines connected to the odd pixels;
a plurality of second gate lines connected to the even pixels;
a plurality of data lines connected to the pixels;
a gray voltage generator generating a plurality of gray voltages;
a first gate driver connected to the first gate lines to drive the switching elements of the odd pixels;
a second gate driver connected to the second gate lines to drive the switching elements of the even pixels;
a data driver selecting data voltages corresponding to image data from the gray voltages and applying the data voltages to the pixels; and
a signal controller transmitting the image data to the data driver and generating and outputting control signals for controlling the image data to the data driver,
wherein the data voltages include first data voltages for odd pixels and second data voltages for an even pixels, the image data include the first image data for the first data voltages and the second image data for the second data voltages, each pair of the first and the second gate lines connected to the odd and even pixels in a row are alternately supplied with a gate-on voltage from the first and the second gate drivers, respectively, to turn on the switching elements connected thereto for one horizontal period, the data driver outputs the first voltages for the odd pixels during a period that the first switching elements are turned on and outputs the second voltages for the even pixels during a period that the second switching elements are turned on, the control signals include an inversion signal for reversing the polarity of the first and the second data voltages and a common voltage applied to the pixels having a magnitude varying dependent on the polarity of the data voltages, and the signal controller changes a state of the inversion signal between an end of the transmission of the first image data and a start of the transmission of the second image data and the polarity of the common voltage between an end of the application of the data voltages for a row and a start of the application of the data voltages for a next row.

9. The liquid crystal display of claim 8, wherein a phase of the common voltage is delayed by half of a horizontal period with respect to a phase of the inversion signal.

10. The liquid crystal display of claim 8, wherein a period of the inversion signal and a period of the common voltage are equal to two horizontal periods.

11. The liquid crystal display of claim 8, wherein the odd pixels and the even pixels are connected to the data lines in pairs.

12. A method of driving the liquid crystal display including a plurality of odd and even pixels arranged in a matrix, the method comprising:
supplying image data for the odd pixels, an inversion signal, and a common voltage;
reversing a state of the inversion signal;
supplying image data for the even pixels; and
reversing a state of the common voltage.
